(19) United States
(12) Patent Application Publication
(10) Pub. No.: US 2003/0083972 A1
(43) Pub. Date: May 1, 2003

(54) Methods for issuing, distributing, managing and redeeming investment instruments providing securitized annuity options

(76) Inventor: James Benjamin Williams, Sherborn, MA (US)

Correspondence Address: CHARLES G. CALL, 68 HORSE POND ROAD, WEST YARMOUTH, MA, 02673-2516, US

(21) Appl. No.: 10/273,542

(22) Filed: Oct. 19, 2002

Related U.S. Application Data
(60) Provisional application No. 60/348,035, filed on Oct. 19, 2001.

(51) Int. Cl. G06F 17/60

(52) U.S. Cl. 705/36

(57) ABSTRACT

A method of issuing and managing investment instruments called “Pension Shares” which preferably take the form of securities that represents a claim against and is secured by an investment fund. A Pension Share entitles its holder to receive, at a specified maturity date, either a lump sum payment amount or, at the option of said holder, to receive a sequence of annuity payments. The Pension Share issuer creates and manages the investment fund such that its net asset value at the maturity date will be adequate to make the lump sum payment or provide the holder with the annuity. A preferred form of Pension Share provides an annuity option of one dollar per for the life of the holder, or his or her survivor, both of whom are at a predetermined age at the maturity date. A Pension Share may be redeemed on demand in advance of the maturity date so that it may be exchanged for a Pension Share having a different maturity date if the holder's plans change.

### CROSS-REFERENCE TO RELATED APPLICATION

This application claims the benefit of the filing date of the copending U.S. Provisional Patent Application Serial No. 60/348,035 filed on Oct. 19, 2001.

### BACKGROUND OF THE INVENTION

Until the last century, Americans generally worked as long as they were able and relied on their families for support in old age. But over the course of the last 100 years, we have gradually come to expect an independent retirement at or around 65 years old. These new expectations are the product of government programs (primarily Social Security) and the defined benefit plans, or pensions that have been widely provided by employers. Pension plans typically reward years of service with secure retirement benefits and, from the employee's perspective, retirement is funded almost invisibly. Employers oversaw the investment of pension funds and assumed the market risk.

Pension plans have several drawbacks for employees and employers alike: the benefits are not portable, and may be lost when an employee leaves the company; employees have no control over or access to their benefits before retirement; the pension fund could fail if the employer becomes insolvent; and the employer's profits include not only the results from business operations but must reflect the employer's pension fund's investment losses as well. In recent decades, “defined contribution” plans have largely displaced pensions. These plans are sponsored by employers but are funded voluntarily by employees. Their strengths include: ease of participation; tax-deferred contributions by employees; full employee ownership (vesting) of their own contributions; portability when changing employment, either to other plans or to Individual Retirement Accounts (IRAs); flexibility in the amount and timing of contributions; borrowing privileges; and choice of investments.

Through defined contribution plans, employees gained ownership and control of their retirement funding, but assumed complete responsibility for saving enough and obtained no shelter from investment risk. Employees like the control, and employers like their reduced responsibility and risk.

A growing number of policy makers see the shift to defined contribution plans as harmful to employees because most save too little, can't adequately forecast how much money they will need, and often manage the investments they do make poorly. Defined contribution plan participants want to know what to expect for income in retirement, but with self-direction they don't know how much to save or how to invest. Retirement calculators have proven ineffective, and investment advisors have not been effective or available to give confidence.

While guaranteed investment products, such as deferred annuities and guaranteed investment contracts, are available today, they are intimidating and complicated from the buyer's standpoint.

Deferred annuity contracts are typically sold in exchange for a lump sum premium, possibly with a contract to make additional payments until retirement, and grow at variable rate (sometimes with partial guarantee of rate) until retirement. Annuity contracts typically make payments for single life, joint life, or for period certain, with other options for minimum payout and recovery of some amount of cash value. While these features are desirable, conventional deferred annuity contracts exhibit most if not all of the following significant disadvantages: the rates of return is either not guaranteed, or guaranteed only for a short term; annuity contracts are typically complex and hard to understand, making it difficult for most investors to make the sound choices needed to properly fund their retirement; annuity contracts are not liquid and may only be exchanged for a sum which is aptly named the contract's “surrender value;” annuity contracts cannot be altered or exchanged to provide a different maturity in case the investor's seeks earlier or later retirement or otherwise changes plans; and annuity contracts are subject to insurance regulations that vary from state to state, adding overhead and complexity.

It is accordingly an object of the present invention to combine the best features of defined benefit and defined contribution plans in order to provide secure returns, portability, and access in an investment product that may be readily understood by investors and that provides a defined benefit that is structured to fit easily into defined contribution plans and the channels that market and service those plans.

### SUMMARY OF THE INVENTION

The present invention takes the form of a method for issuing a “Pension Share”, which may take the form of a security or a contract, and for managing the investment which funds the obligation represented by the Pension Share. The management process consists of an accumulation process and a payout process. The accumulation process seeks to produce a particular net asset value at a specified future maturity date. The payout provides the holder of the Pension Share with the option to obtain either a lump sum cash payment or a lifetime annuity, the terms of which are specified by the Pension Share instrument (e.g. paying the holder $1 per month per share for the life of holder). Pension Shares can be purchased or redeemed daily at a published net asset value (NAV). Since individual Pension Shares mature at a specified date, they may be exchanged for other Pension Shares having a different maturity.

A Pension Share as contemplated by the invention incorporates a “Normalized Annuity Option” (NAO) which is a security or contract that gives the NAO holder the right to purchase a life annuity of specified terms at a defined date in the future for a predefined price, adjusted by age, etc., but not adjusted by population mortality assumptions or interest rates. The NAO can be thought of as a call option on a defined annuity product, or, financially, as an interest rate put option and a call option on a population longevity index.

In the past, insurance companies have offered deferred annuities and life insurance policies routinely contained an option permitting the holder to take either a lump sum payment or to convert to a payout annuity with adjustments and at a guaranteed rate. However, the option is not to be securitized, i.e., split out as an instrument on its own. The packaging of the option as a securitized instrument is important because it facilitates the creation, issuance and marketing of securities and/or insurance policies which incorporate the securitized annuity option.

In accordance with an important feature of the present invention, the securitized annuity option clearly reveals the present value of the future choice. The NAO becomes an asset, not simply a cost, and the purchase price is set by market conditions and thus ‘discovered’ and made available to both buyers and sellers to inform their decision making and planning. In contrast, prior deferred annuity products hide the value and do not make that value available to policy holders. Should the embedded annuity option have a market value, the holder cannot realize it except through obscure or complicated arbitrage.

The securitization of the annuity option provides significant advantages, such as standardization, fungibility, transferability, and preserves the ‘anonymity’ of the holder until exercise. The securitized annuity may be advantageously offered in the form of a mutual fund although, as described in more detail below, specific preferred methods of issuing and managing such mutual fund Pension Shares may be employed to comply with applicable regulations while preserving the efficiency and advantages provided by the securitized annuity option.

When the accumulation contemplated by the invention is embodied in mutual fund shares, it may be advantageously implemented using an “internalized longitudinal collateralized bond obligation” (LCBO). In the LCBO, a portfolio of corporate bonds packaged to make a new Asset Backed Security, securities are tranched by date to match the maturity dates of the accumulation, thereby simplifying the management of the funds in the face of changing interest rates.

These and other features and advantages of the invention will become more apparent through a consideration of the following detailed description. In the course of this description, reference will be made to the attached drawings.

### BRIEF DESCRIPTION OF THE DRAWINGS

FIG. 1 is a flow chart showing the method or accumulating and paying out a Pension Share which provides a Normalized Annuity Option in accordance with the invention;

FIG. 2 is a flow chart which illustrates the accumulation process employed to securitize the annuity option; and

FIG. 3 is a chart graphically depicting factors that influence the pricing of a Normalized Annuity Option (NAO).

### DETAILED DESCRIPTION

### Overview

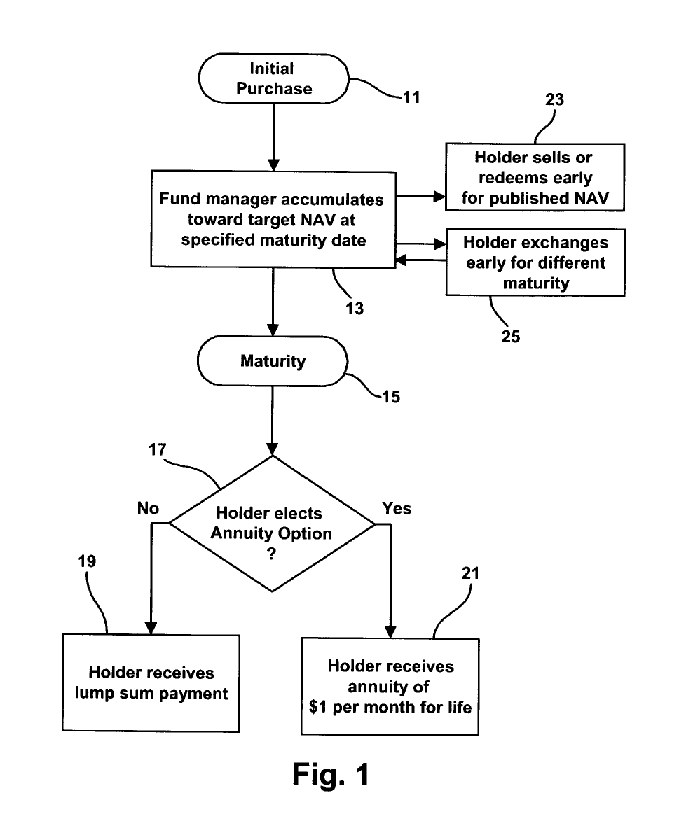

A “Pension Share”, which may take the form of a security or a contract, is issued to an initial purchaser as seen at 11 in FIG. 1. The funds which secure the obligation represented by each pension share are managed by a process consisting of an accumulation process and a payout process. The accumulation process shown at 13 seeks to produce a particular net asset value at a specified future maturity date 15. The payout provides the holder of the Pension Share with the option at 17 to obtain either a lump sum cash payment 19 or a lifetime annuity 21, the terms of which are specified by the Pension Share instrument (e.g. paying the holder $1 per month per share for the life of holder) when issued at 11.

Pension Shares can be purchased or redeemed daily at a published net asset value (NAV) as indicated at 23. Since individual Pension Shares mature at a specified date, they may also be exchanged for other Pension Shares having a different maturity as shown at 25.

The summary that follows subdivides the methods by which Pension Shares are issued, funded and paid out into three phases: The accumulation process 13, the maturation process that occurs at 15, and the payout process at 17, 19 and 21. Each of these phases is then further subdivided into its component steps. In the course of this summary, certain terms are defined which are used in the description that follows. In addition, the summary points out available alternative methods as well as considerations which bear upon the selection of the preferred methods.

As used here, the terms “share” and “unit” mean the same thing: a share, participation, claim against the assets, or other interest in an issuer or in property or an enterprise of an issuer.

A Pension Share is an investment product that is packaged as shares or units. More specifically, a Pension Share may take the form of a contract, but is preferably a “security” as that term is used in Article 8, Investment Securities, of the Uniform Commercial Code. More specifically, the term “security” as used herein means a share which is:

(i) represented by a security certificate in bearer or registered form, or the transfer of which may be registered upon books maintained for that purpose by or on behalf of the issuer;

(ii) one of a class or series or by its terms is divisible into a class or series of shares, participations, interests, or obligations; and

(iii) which (A) is, or is of a type, dealt in or traded on securities exchanges or securities markets; or (B) is a medium for investment and by its terms expressly provides that it is a security governed by Article 8 of the Uniform Commercial Code.

In accordance with the invention, issuer of a Pension Share promises to pay to the holder of the security at a stated maturity date either a predetermined lump sum payment or, in the alternative and at the option of the holder, to pay a sequence of predetermined annuity payments at defined times. Pension Shares are issued to holder in advance of the maturity date in return for a purchase price payment. Pension Shares are fungible, their ownership is not confined to natural persons, and they may be bought, sold, exchanged, and redeemed by the current holder.

Insurance products are contracts that can simulate many features of securities. For example, a variable annuity can work like a mutual fund, with investments held in a separate account, insurance products can even include direct investments in securities, and net asset value pricing (NAV) can be simulated with market value adjustment (MVA) procedures defined in the product. Similarly, securities can simulate features of insurance. For example, put and call options are explicitly treated as insurance instruments; structured securities and mutual funds can have external guarantees, such as ‘capital preservation funds’ that guarantee your initial investment back; the NAO provides conversion to annuities. Because of this convergence of features, each type of product can be subject to dual insurance and securities regulation, but the external packaging of the product remains either insurance or security.

While the security packaging is preferred for Pension Shares, an insurance product can be constructed that provides most of the same benefits as the security. In the U.S., deferred annuity products have a tax deferral characteristic that the security version would not have outside of a tax-qualified retirement account. For example, a deferred annuity could be configured to provide the Pension Shares features of: sold in units of benefits (such as the $1/month/unit option at maturity) with a target unit lump sum value, flexible purchase at net asset value or a published buy and sell price, flexible redemption before maturity at net asset value or the buy and sell price, maturity easily changed or units exchanged from one maturity to another. Such a deferred annuity product would be further enhanced by holder anonymity during accumulation (e.g., removing features such as a death benefit that tie the contract to a particular holder, invade privacy, or otherwise increase the cost of the contract). The product could also be enhanced by using an NAO to represent the guaranteed annuity conversion rate of the product. The NAO has the advantage that its price can be included in the net asset value unit price or the buy/sell price, thus revealing the value of the option as an asset. Without the NAO, the traditional practice is that the cost of providing the option is revealed as an expense of (fees charged to) the product, which can leave the underwriter in flexible purchase contracts vulnerable to the annuity option being ‘in the money’ at maturity. Similarly, the holder cannot easily extract the economic value of an in the money option if he does not want the annuity.

As noted above, the methods by which Pension Shares are initially issued, funded and paid out may be subdivided into three phases: the accumulation process, the maturation process and the payout process. Each of these three phases is summarized below.

### The Accumulation Process

The manner in which funds are accumulated to meet the obligations defined by a Pension Share is characterized by both the nature of the entity issuing the security and by the investment process that is employed to accumulate funds to meet the obligations represented the by the Pension Share.

The entity issuing the Pension Shares is preferably a “transparent issuer” but may be an “opaque issuer.” When Pension Shares are issued by a transparent issuer, the shares or units represent proportional claims on the assets held by the issuer, such as a mutual fund or collective trust. When Pension Shares are issued by a transparent issuer such as a mutual fund, they may be readily distributed through conventional channels, such as IRA accounts. However, mutual funds have higher fixed costs and are more closely regulated than are obligations from an opaque issuer. A transparent issuer must hold contracts or obligations from an external entity, such as an insurance company, in order to make accumulation guarantees. Shares that represent obligations of an opaque issuer, such as an insurance company, are backed by the issuer's own capital, and accumulation guarantees can be relied upon only to the extent of the issuer's capital and resources. Opaque issuers that market Pension Shares have the opportunity for higher profit, since they can keep the residuals if they manage well, but they bring single-firm risk to investors, since failing to manage well will create losses for the firm and it may default on its obligation to the investors. There can be hybrid issuers, such as an insurance company (opaque) using separate accounts (a transparent vehicle) to maintain the Pension Share investment.

The accumulation process which the issuer follows in order to meet the obligations of an issued Pension Share security is selected based on the whether the Pension Share, as issued, specifies that the lump sum amount to be paid is a fixed target, an indexed target, a variable target, or a variable target with a minimum.

If the lump sum is “fixed target,” the lump sum amount a Pension Share obligates the issuer to pay at maturity is intended to be met exactly and represents a fixed rate of return from the initial purchase of a Pension Share to maturity. A transparent issuer of a fixed target Pension Share will accordingly invest in a portfolio with a duration that matches the time to maturity. This can be done with an “immunized portfolio,” with instruments of fixed duration such as zero-coupon bonds, or with investment products with sequential maturities that create the effect of zero-coupon instruments by internal stripping.

A Pension Share with an “indexed target” is like a fixed target, but the target amount is adjusted in a defined way in accordance with changes to an index value, such as an inflation index, to preserve the purchasing power of the target amount to be paid at maturity. When the Pension Share obligates the issuer to pay an indexed target amount, an accumulation process is chosen which incorporates investments whose value is more likely to track the selected index, such as U.S. Treasury Inflation-Indexed Notes and Bonds.

A Pension Share which defines the lump sum payout as a “variable target” does not set a return that can be predicted or managed with any certainty, but rather defines an investment process. Examples of the accumulation process for a variable target payout include investing in stocks or stock indexes.

A Pension Share may define a “variable target with a minimum” by defining a guaranteed minimum payout that is intended to be met or exceeded if the defined investment process performs well. To meet the obligations imposed by a variable target with a minimum, the accumulation process may take the form of a combination of investing in stocks or stock indexes and stock put contracts, index puts, or portfolio insurance wraps.

### The Maturation Process

The manner in which a Pension Share matures depends both on the nature of the “maturity date” and the nature of the “conversion process” which occurs at the maturity date.

A Pension Share may mature at a fixed maturity date, or at a variable maturity date. When Pension Shares mature at a fixed date, processing at the time of liquidation is significantly simplified and the Pension Shares need not define the manner in which the payout is adjusted to provide a variable maturity. Different Pension Shares may have different fixed maturity dates and, a holder can exchange shares having one maturity for shares having a different maturity if the holder's planned time of retirement changes. Alternatively, the holder may redeem shares early to “cash out” and possibly purchase a different investment product if the holder's plans change. Thus, the simplification provided by a fixed maturity date need not significantly restrict the flexibility that the holder enjoys.

At the maturity date, the holder receives either a lump sum payment or, in the alternative, converts the lump sum value into a series of timed payments. The lump sum amount may take the form of target amount, a variable amount, or a guarantee amount.

A range of dates before and/or after the maturity date may be allowed for converting the lump sum into payments. The range is desirable, however, to allow individual holders to adapt the payout to their personal situation. In case a range of conversion dates is allowed, additional constraints may be imposed to specify any changes or adjustments to the conversion process. For example, before maturity the accumulation process may not have built up a value equal to the lump sum, so the payout would be adjusted pro rata. In practice, if the share value is higher than the lump sum, adjustment higher than the guaranteed payout would not be permitted to protect the NAO underwriters from the risk of accumulation overruns.

The target amount is the value resulting from the accumulation process used to manage the fund as described above with the intent that the lump sum will have the target value at maturity, but the target may not be met since the issuer is a transparent issuer and has no resources other than its defined assets to make up any deficiency. As noted above, the target amount paid at maturity may be a fixed target value, an indexed target value, a variable target value, or a variable target value having a “guaranteed” minimum.

A variable amount lump sum payment is simply the accumulated return from the initial investment and has no relation to a target amount, guarantee or “defined amount” (described below).

A guarantee amount may be either a defined money amount or a defined minimum amount (which a transparent issuer must secure with insurance from a financial guarantor, or which is backed by the full faith and credit of an opaque issuer). A defined minimum amount may be exceeded, but only the stated minimum value is guaranteed.

At maturity, the holder may elect to convert the lump sum amount into one of three possible alternative forms: a payout security (that is not contingent on the life of the holder); an annuity contract; or an option to obtain an annuity contract.

### The Payout Process

The amount of money needed to fund the payout of a Pension Share at its maturity (here called the “defined amount”) is calculated or estimated as a function of:

a. the payment amount,

b. the initial payment adjustments,

c. the periodicity of the payments,

d. the conditions under which payments continue, and

e. estimates of likely future interest rates and mortality curves available at the time of conversion.

The “payment amount” may be simply a fixed payment (a defined money amount that is constant for all payments). An incrementing payment in which successive payments increase a defined rate (e.g. 3% annually) provides some protection against inflation which is desirable as life expectancies continue to increase. Otherwise, even with moderate 3% inflation, the purchasing power of a fixed payment would drop in half between age 65 and 90; 90 is only about 1 ; standard deviation above median life expectancy for 65 year olds. An incrementing payment is easy to price and build, and is readily understood by Pension Share purchasers.

The payment amount may be an indexed payment where successive payments are adjusted based on an index, such as an inflation index. In the U.S., there are not many inflation indexed investments that can back or hedge COLA (Cost of Living Allowances) products, so such products tend to be expensive. Overseas, indexed investments are more common. Indexed payments are generally preferable to variable amount payments (in which successive payments are adjusted as a function of the performance of an investment portfolio) because indexed payments more effectively shield the holder from risk.

The Pension Shares may further define initial payment adjustments which, for life-based payments, are adjustments made using a defined table or mathematical function that makes actuarial adjustments to the initial payment amount. These adjustments are typically a function of data such whether the annuity is joint and survivor or single life, and the sex and age(s) of annuitant(s).

The Pension Shares payout process further defines the times at which payments are transmitted to the holders or beneficiaries (e.g. monthly, quarterly, annually, etc.) and the conditions under which payments continue, including a period certain (i.e. a defined number of payments) or preferably as a life annuity, which may be for a single life, or as “joint-and-survivor” payments that when only one annuitant is alive (e.g. 50%, 75%, or 100% of the payment made when both are alive). A life annuity may be accompanied by a minimum cumulative payment or minimum number of payments.

At the time of conversion to an annuity, the holder is allowed to choose between single and joint-and-survivor plans, and whether or not there will be a minimum payment. This choice is one of the factors that affects the amount of payment which is to be made based on the defined value of the Pension Share at the time of conversion to an annuity. Note that, in the United States, retirement plans are required to default to spousal inclusion in benefits; consequently, a joint-and-survivor plan will be used unless the holder affirmatively chooses a different payout process. For simplicity, the preferred “benchmark” terms for payout by a single Pension Share would provide a payment of $1 (one dollar) per month for the joint-and-survivor's lifetime.

### DESCRIPTION OF THE PREFERRED EMBODIMENT

The present invention takes the form of a method for issuing a new kind of security called “Pension Shares.” Pension Shares can be thought of as bundling two components:

1. A fixed terminal value component guaranteeing a predefined lump sum value per share at maturity (analogs are zero-coupon bonds or long-term bullet GICs);

2. A Normalized Annuity Option (NAO) contract guaranteeing that the lump sum value of the share at maturity can be converted to a joint and survivor life annuity paying $1 per month per share, with the actual payout adjusted based on the ages of the annuitants at conversion. In other words, this is a security that represents a unit of guaranteed annuity purchase rates.

“Normalized” refers to the fact that the terms of the NAO are based on circumstances that are hypothetical when the Pension Share is purchased, and defined so that a particular common case results in the $ 1 per month payout. The NAO contract component of a Pension Share is an “option” because the holder is not required to convert the lump sum into the annuity, and may choose instead to take the lump sum as cash.

The specifications for the Normalized Annuity Option (NAO) need to be both financially conservative and contractually conservative. The NAO should be ‘financially conservative’ in that it should be easy to value and not be subject to speculative extremes in pricing. The implied interest rate of the annuity can be high or low, but low is preferred so that the value of the NAO is a small part of the value of a Pension Share. While the outcomes will be essentially the same, the low rate assumption focuses the holder's attention on the rate of return to maturity without introducing a large element of speculation on interest rates at the time of maturity.

By ‘contractually conservative’ it is meant that the NAO contract delivered as a result of exercise of the option should be widely available, easy to understand, and writable in all regulatory jurisdictions where the Pension Shares will be sold.

In general, expect that the NAO will not be exercised. Instead, holders will tend to prefer either the lump sum or another payout product that better fits their particular needs, has a higher interest rate, includes variable returns or inflation indexing, or implements any of the dozens of other annuity features available. The NAO is included in Pension Shares because it:

a) Creates a floor or guarantee the holder can depend on;

b) Allows Pension Shares to be priced in a way that is more meaningful than other products (in other words, the share defines the benefit). This meets our goal of a providing a defined benefit within a defined contribution plan;

c) Has the side effect of creating interest in guaranteed payout products among holders.

Pension Shares are designed to be attractive at all links in the defined contribution value chain, including the following benefits for NAO underwriters:

a) The price of a Pension Share includes a premium for the NAO underwriter;

b) The NAO underwriter has a new, very low cost institutional source of demand for annuities. The underwriter's other products will usually be attractive compared to the NAO annuity.

One feature of Pension Shares is that prior to maturity, an “assignment” process links holders to a single annuity underwriter for all of that holder's shares. This one-to-one retail relationship is an opportunity for the underwriter to market other investment or retirement payout products to the holder. There may be an exception to this, where the shares are pre-assigned when issued, in cases where the plan provider is, or is related, to an NAO underwriter. In that case, the pre-assigned underwriter would be subject to other constraints, such as a requirement to fulfill all demand from its provider.

A single NAO issuer can be used to advantage. Instead of assignment, all annuities are written by one underwriter, and the annuities are pooled by means of reinsurance. This spreads the risk of annuity default across many insurers, pooling that risk, and makes it true that all holders who take annuities face identical risk. Regulators will see that non-discrimination among holders is important.

### Investment Policy and Procedures for Pension Shares

Pension Share portfolios are managed to meet a target net asset value at the defined maturity date which involves a number of challenges, particularly within the mutual fund structure as defined by the Investment Company Act of 1940.

Traditionally, mutual funds start with the initial investment, apply a process, and hope for the best. The process of funding Pension Shares instead starts at the end, with the benefit or result, and works backwards to determine what the initial investment should be.

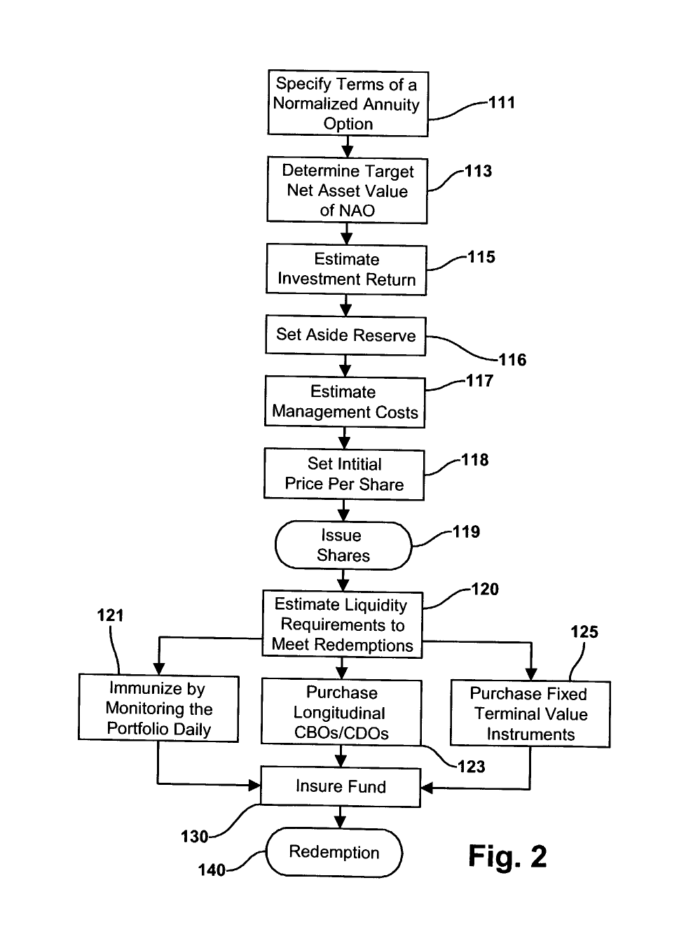

The procedure begins, as seen at 111 in FIG. 2, by specifying the terms of the Normalized Annuity Option (NAO), an instrument (either a security or a contract) equivalent to the guaranteed annuitization feature of a deferred annuity. The NAO grants the owner of a Pension Share the right but not the obligation to buy a life annuity or other payout product on predefined terms at a date in the future regardless of market prices for such annuities at that time. The annuity terms which are to be established at step 111 include:

a) the maturity date (i.e., date of option exercise);

b) a payout table (payout as a function of the number of annuitant(s), their sex, age, etc.);

c) the annuity premium;

d) the legal features of the annuity contract to be delivered; and

e) the underwriting fees, per annuity contract.

The important item for the portfolio manager is setting the annuity premium, since that establishes the target Net Asset Value (NAV) which is determined at step 113.

Working backwards from the target NAV, an accumulation process must be followed which is calculated to safely achieve the NAV. The investment return needed from inception to maturity, excluding expenses, is determined as shown at 115. The net investment return must also include the risk of default and recovery in the investments through maturity, and account for the expenses of the guarantee, whether through the purchase of portfolio default insurance, through allowance for reserves, or both as indicated at 116. Some policy and style decisions will feed into these estimates as summarized below:

The fund may be administered by active management or alternatively by passive or indexed approaches. Passive management can reduce costs, and the ultimate performance of these products will be very sensitive to costs. Credit spreads historically range from too-low (risk underpriced) to too-high, so there should be opportunities for an active manager to stick with government securities when spreads are low and enhance returns with corporate bonds when spreads are historically high.

As discussed in more detail below, Pension Shares may be funded by (1) “risk-free” assets, (2) insured assets/portfolios, or (3) reserves, or a combination of these. Currently, peak yields are about 5.40% for 2024 Treasury STRIPS, 5.95% for FNMA 0s of '19, and about 7% for 20 year coupon AA financials. The horizon for credit or default swaps is currently limited to about 5 years, and there has been no market for insuring corporates for very long terms. While insurance for municipal bonds exposes ‘inefficiencies’ in the ratings and pricing of that market, it may be that the price of insurance for baskets of corporates would equal or exceed the spread. Internal reserving would be very efficient, but adds some uncertainty to performance and can make the yield to target NAV look low even if the yield to probable maturity NAV is competitive.

As indicated at 117, the cost of managing the fund, including shareholder servicing costs and the cost of fund administration, investment management, and transaction costs must also be estimated.

As seen at 118 in FIG. 2, the foregoing information may be used to calculate the initial share price, P₀, using the following relation:

P₀=pv(Vₘ+Rₘm,r_{g}−rₓ)+Nₘ

where the variables used have the following meanings:

Nₘ NAO price for maturity

pv( ) present value(future value, periods, rate per period)

Vₘ target net asset Value at maturity

Rₘ dollar reserve for credit losses (defaults less recoveries) per share at maturity

m number of years to maturity

r_{g} gross yield to maturity of the portfolio

rₓ average annual expense expressed as a rate per year (alternatively, annual expenses may be accumulated to maturity and included in the reserve, Rₘ).

Fortunately for retirement products, the net of new share purchases minus redemptions is fairly predictable and usually positive. The fund's ability to meet its target NAV is impaired any time net redemptions caused assets to be sold at a value less than the value used in calculating the NAV (due to the spread between bid and asked prices for a security). An optimal cash level can be estimated, depending on the returns on cash relative to the next most liquid securities, the spreads in the prices of the next liquid securities, and the probable distribution of net cash flows into and from the fund. This impairment can be mitigated or eliminated with redemption fees (paid to the fund for premature share redemptions) as discussed in more detail below under the topic Redemption Costs in the section entitled Building Pension Shares. Currently, a 1% redemption fee until the last few years before maturity appears to be more than adequate to protect the portfolio from impairment. As maturity approaches, the redemption fee can be reduced as trading spreads narrow and portfolio liquidity increases.

Circumstances which unfold after the Pension Share is issued at 119 must also be taken into account.

As seen at 120, the fund manager must estimate liquidity requirements to meet normal redemptions to a given certainty (e.g., two standard deviations). The liquidity requirements estimated at 120 indicate the target allocation to cash and highly liquid securities which is to be maintained in the portfolios

Three alternative methods have been developed for managing the fund during the accumulation process as indicated at 121, 123 and 125 in FIG. 2.

### Method 1: Immunization

This method shown at 121 uses traditional techniques for matching the assets held by the fund to the ‘liability’ implied by the target NAV and maturity date. The duration of the portfolio will be managed to equal the time to maturity, so the ultimate value of the portfolio will not be affected by changes in interest rates along the way.

Using the traditional techniques, a prototype allocation within the portfolio includes the following components, listed in order of decreasing liquidity:

| Instrument | No Res. Or Ins. | Res./Ins. |
|---|---|---|
| Liquid Securities | | |
| Cash and equivalents | 1% | 1% |
| Treasury and agency | 84% | 9% |
| Corporate bonds | | 75% |
| Illiquid Instruments | | |
| Bullet GICs or similar | 15% | 15% |

In the table above, both the Corporate Bonds and the Bullet GIC (Guaranteed Investment Certificates) or similar instruments are typically high quality, investment grade, and the GICs are without put or redemption features.

The traditional immunization strategy illustrated at 121 requires that the portfolio be constantly monitored and that its composition be adjusted with changes in the term structure (yield curve). With a static fund that has no cash flows, the manager would need to periodically buy and sell securities to bring the portfolio back to the proper duration. Fortunately, with normal net inflows, the manager can be more efficient by buying additional securities that correct the portfolio's duration without also having to sell other securities, thus reducing turnover and trading costs.

The portfolio manager also needs to monitor credit quality. Unfortunately, simply selling any asset when it is downgraded cumulatively has the same effect as defaults since the price of the asset drops in the event of, and even before in anticipation of, a downgrade. The manager will need to make judgments informed by quantitative models of the relative value of holding a possibly defaulting asset versus immediately realizing a loss. This strategy will be controlled by requirements of any insurance or credit derivatives used to mitigate default risk, and by the rating agencies if the funds are rated.

Other than treasury and agency securities, the portfolio must be diversified across sectors of the economy. There is no need to invest internationally since the liability is domestic and denominated in local currency. Bullet GICs are used get exact duration matches, to obtain management and portfolio diversification as a claim on general accounts of various insurers, and possibly a premium return for the long-term commitment (lack of liquidity).

Under the strategy shown at 121, the portfolio is monitored daily (policy enforcements can be performed in real time) in order to:

a) maintain liquidity

b) keep allocations within predetermined policy limits and regulatory limits

c) maintain duration match within limits

d) keep portfolio diversified

e) monitor and maintain credit quality.

### Method 2: Longitudinal CBO/CDO

The second strategy, shown at 123 in FIG. 2, is to use a Collateralized Bond/Debt Obligation structure, where a pool of bonds is shared among the funds in the series (and perhaps external participants). But instead of tranches based on repayment priority, the tranches are based on time: coupons and principal repayments are assigned to the tranche matching the year (or other period) in which they occur. Owners of the tranches therefore get a diversified instrument with a fixed duration (zero convexity). This process is much like ‘stripping’ of treasuries, with shares of each tranche becoming zero-coupon instruments. Further, this approach scales well, since you can have one very large portfolio instead of 15 to 20 small portfolios. There can be more or fewer portfolios, for longer or shorter terms, based on market acceptance and costs, The scale makes management more efficient and makes diversification easier. Insurance wraps and default swaps can be used to further enhance the effective quality.

An important additional innovation is the “internal LCBO”, where the funds in the series cooperate to become collectively the CBO as described below under the topic “Issue Level Stripping” in the section entitled “Building Pension Shares.” Here, a long maturity fund buys bonds that mature in the same year as the fund. It then ‘sell’ the coupons to the shorter-maturity funds by means of forward contracts. Each fund still has responsibility to maintain liquidity, but duration management is a much reduced issue. Under the longitudinal CBOs/CDOs approach shown at 123, all fund portfolios are monitored simultaneously to:

a) maintain liquidity of each fund

b) keep allocations within predetermined limits

c) keep portfolio diversified

d) monitor credit quality

e) match maturities and coupons to the maturities of the “assigned” funds.

Each fund is still likely to have assets that it does not ‘share’ or that it partially shares with other funds, simply because the flows into the funds will vary by fund maturity day to day and over time. Since this approach is novel, software to help optimize the allocation of maturities across all funds simultaneously will be developed.

### Method 3: Fixed Terminal Value Instruments

As seen at 125, a third mechanism for funding Pension Shares is to purchase Fixed Terminal Value instruments. FTVs are contracts like bullet GICs, except they are standardized, reinsured for uniform high credit quality, and easily tradable and liquid. FTVs may be traded on an exchange formed to be the issuer and clearing facility for FTVs. In this case, the work of portfolio management would be almost entirely distributed to the underwriting members of the exchange. Bullet GICs with redemption or put features may serve as FTVs.

### Insurance

There is ample precedent for using insurance wraps to create guarantees for funds and products around corporate debt, but not for the long time horizons envisioned for Pension Shares (20 or more years, versus 5-7 years for guaranteed rates in fixed annuities, capital preservation mutual funds, default swaps, etc.). Insuring municipal obligations is a mature industry that demonstrates long-term insurance, but municipalities are arguably more stable than corporations.

That said, it would appear that there is opportunity to insure individual corporate credits or baskets of corporates. For high-quality and investment grade corporates, the credit spread usually more than compensates for observed defaults over long periods. The same is not clear for high-yield (junk) bonds, but these are not under consideration for Pension Share products. At any rate, spreads vary over time from questionably thin coverage for default risk to comfortably rich coverage for a diversified portfolio. As discussed below, this credit spread may be split with a financial guarantor in exchange for insuring the portfolio against defaults.

Lacking long term insurance structures or instruments, other approaches may be used to get the same effect. For example, intermediate term credit spread swaps may be chained to achieve the effect of a longer term default swap. In essence, a deteriorating credit would see an expansion in spread before actual default; if the credit is deteriorating, the loss would be offset by the swap, allowing the manager to sell that credit when the swap expires without incurring the entire loss.

### Reserving

A straightforward approach to meeting the target NAV when the ultimate return of assets cannot be guaranteed is to hold assets in excess of the target as indicated at 116. Simply, if the yield to maturity net of expenses indicates that $60 of assets now will meet the target of $200 in twenty years, given a 10% default estimate, $66 in assets could be held in reserve to allow for defaults and unforeseen adverse events and expenses. The advantages are simplicity, understandability and transparency (shareholders will see that this approach increases the likelihood of meeting the target, and gives them an opportunity for additional returns if the reserve is larger than needed). The downside to setting aside a reserve is that the apparent return of the shares to target NAV is reduced, and may not be competitive if the comparative analysis is superficial and does not account for default risk. Continuing the example, if net yield is estimated as 6.20% for 20 years, implying an initial price of $60 per share, an initial price of $66 (i.e., reserve of 10%) would appear to be a return of 5.71%. Worse, if after many years the reserve is completely intact, the return could appear to be negative, if for example the NAV rises to $210 and the announced target remains at $200. An insurance firm will operate under this model. As reserves are discovered to be actuarially excess over time, they can be taken as profits, or if the reserves are inadequate, then the firm makes up the difference and realizes a loss.

The yield to maturity with reserves is approximated by the formula:

Y_{R}=[(1+Y_{G})^{M}(1−RD_{M})]^{1/M}−1,

where

Y_{R} is Yield with Reserves,

Y_{G} is Gross Yield,

D_{M} is cumulative default rate over M years,

R is the Reserve Factor, or the multiple of the cumulative default rate to be reserved,

M is the number of years to maturity.

### NAO Terms

The representative terms of the preferred form of normalized annuity option component of a Pension Share may be summarized as follows:

Maturity Date: Each Pension Share matures on June 30th of the maturity year for that issue. Adjustments to the lump sum and NAO for holders may be specified for holders who wish to redeem or convert their shares on other dates within the maturity year.

Initial Maturities: The first issues of Pension Shares would have maturity years over a range of years (e.g. a fifteen year range from 2008 through 2023). An additional maturity is added each year, or more if there is demand.

Lump Sum Amount: Each maturity may have a different lump sum amount specified. The lump sum amount is determined based on the cash needed to fund a normalized annuity.

Payout Adjustments: The Pension Share would specify adjustments to the $1 per month per share payout based on the annuitants' age(s) at conversion, relative to the full benefit age. Also, adjustments are specified for a single-life annuity if selected instead of joint-and-survivor annuity.

Full Benefit Age: The Pension Share specifies the age (typically the Social Security Full Retirement Age) of each of two co-annuitants at which the payout will be $1 per month per share. Adjustments are relative to this age.

Annuity Contract: The NAO, if exercised, requires delivery of either a fixed-rate 100% joint-and-survivor immediate Annuity, or a fixed-rate single life annuity, depending on holder's choice, with payout adjusted based on annuitant(s)' age(s). The contract is funded by the lump sum amount, which is not adjusted.

Conversion Minimum: The Pension Share specifies the minimum number of shares (or total lump sum) that can be converted by a holder. Alternatively, the Pension Share may specify a defined per-annuity conversion fee that pays the underwriter for the expenses of issuing and servicing the contract.

NAO Premium: This is the price paid by the Pension Share issuer to the annuity option writer when a Pension Share is issued.

Failures: The Pension Share specifies what happens in the event of unwelcome circumstances (e.g., the NAO underwriter fails to meet certain covenants, such as credit rating, before or at maturity; or the Pension Share fund fails or is prematurely dissolved.

### Dynamic Contract

The master NAO contract is preferably a dynamic or continuous contract, where the balance of the NAOs underwritten can change daily. The change in the balance occurs at a price set daily. Ideally, the price is set competitively.

Because Pension Shares are designed for and sold to retirement plans, the number of shares issued will usually be monotonically non-decreasing, i.e., on most days there will be net inflows (sales will be greater than redemptions). However, to be able package Pension Shares as a mutual fund under the 1940 Investment Company Act, the Pension Shares issuer must be able to meet net redemptions with cash. This means that the fund must keep sufficient liquid assets to meet all but the most extraordinary demands for redemption as explained below in the section entitled “How to Build Pension Shares” which contains further details on cash, bond, and FTV portfolio management.

Within some allowable margin of error, the fund must hold one NAO unit for each Pension Share or unit issued. This means that the issuer must be able to buy NAOs each business day, and potentially to sell back a portion of the NAOs written on some days, so the balance must be able to contract as well as expand.

This NAO premium or price is set competitively by normalized annuity option writers, and represents the present value of the risk that at the time of conversion the lump sum will be inadequate to fully fund, in actuarial terms, the adjusted annuity payout. Because the premium is set this way, it doesn't matter if the lump sum is set ‘incorrectly’. The premium is the market price for the obligation to deliver annuities under the terms of the NAO contract for that maturity, so if the lump sum is set too high, the premium will be low, and vice versa. It can be thought of as a premium for an interest rate put, with a strike equal to the benchmark interest rate implied in the normalized annuity in a particular maturity. It also has an aspect of being a ‘call on longevity’ for the holder, with a strike equal to the implied median life expectancy in the normalized annuity.

The function of the NAO already exists in deferred annuity contracts, where the underwriter must agree to the terms of an annuity contract that will come into effect in the distant future, beyond the scope of interest rate forward contracts or other hedges. Unlike deferred annuity contracts, however, in Pension Shares this function is isolated from insurance contracts and is instead packaged as a security so that multiple firms can participate, and the function is given a market price. While multiple firms will compete on price, they also have the flexibility to exit their commitments by buying back the option contracts they have written.

### Estimating the Fair Value of the NAO Premium

The following discussion presents an intuitive model. Disregarding longevity-expansion risk for the moment, and using the approximation

a_{age}⁽¹²⁾=f(age,\vec{q},load,\vec{rates},spread)≈(1+load)·a_{\overline{x}|}⁽¹²⁾=(1=load)·pv(i,x,1)

Where a is the immediate annuity premium,

age is the annuitants' age at inception of the annuity contract,

q is the mortality table, load is the expense of writing the contract,

rates a vector representing the yield curve, and

spread is the profit spread,

i is the interest rate at the time the annuity commences payments, with duration equal to median life expectancy and

x is the median (joint) life expectancy of annuitants (in months in the function notation),

To simplify, we say in the following discussion that the immediate life annuity premium is approximately the present value of the payments over the median life expectancy. The option to purchase a normalized annuity defined with a benchmark interest rate (say, 3%) and life expectancy median assumption (say, 30 years) will be valueless at maturity if prevailing interest rates are greater than the benchmark (and competitive annuities are priced on similar life assumptions), because the holder could buy with the lump sum an annuity on the market that has a higher payout than the annuity delivered by the option. But if interest rates are lower than the benchmark at maturity, an annuity underwriter would be taking a loss to write a normalized annuity contract. Therefore, the NA option behaves like a European-style interest rate put with a strike equal to the benchmark interest rate and a term equal to the maturity. For this discussion we are dropping the load and the spread for simplification.

A theoretical minimum value of the normalized annuity option can be made from the present value of exercise-probability-weighted cost of funding the annuity when future interest rates are below the benchmark. Thus the current price of the option, P, may be calculated using the following equation:

$$P = {( 1 + i )}^{- T} {\int }_{0}^{b} {Pr ( r )}_{T} \cdot ( pv ( r , x , 1 ) - L ) \frac{ⅆ}{ⅆ r} ,$$

where P is the current price of the option,

i is the long-term discount rate when the NAO is priced,

T is the time to maturity,

b is the benchmark interest rate,

Pr(r)T is the probability of rates equaling r at maturity,

pv(r,x,1) is the present value of the unit payment at rate r, i.e., the market price of the annuity under prevailing interest rates, and

L is the lump sum value, defined as approximately pv(b,x,1).

### Inside the NAO

It may be worthwhile to further split the NAO into long-term options on interest rates and options on changes in the ‘force of mortality’ (or longevity expansion), that are separate from the actual annuity contracts. So at maturity,

ä=L+V(I)+V(M),

or, the annuity is purchased for the sum of the lump sum value L plus the expiration value of the interest rate put plus the expiration value of the longevity call M. Since L is predefined, at maturity V(I) is measurable, the annuity premium can be set competitively, and V(M) is an opinion, the actual operation would be to define

V(M)=ä−L−V(I).

A liquid market in this richer set of contracts would allow participating firms to efficiently hedge their portfolio of risks or earn additional income from their asset and liability portfolios.

Another variation is to define the NAO as a purely financial option. Instead of being a call on an annuity contract, the alternate NAO is a call on or other derivative of a Normalized Annuity Price Index, an index that tracks the current market price of the benchmark annuity. Thus, a holder can be sure that no matter what happens, the Pension Shares will have a value at maturity assured to be able to pay for an annuity in the marketplace. A service of effecting the purchase of annuities could be provided separately to shareholders for convenience, but the Pension Share issuer need never directly be involved with annuities, thus possibly relieving Pension Shares security issuers from insurance regulation and licensing. The logical counterparties in this alternate NAO would be insurance companies who face the identical financial risk in their ordinary annuity business and can now securitize it (in fact, in a more direct and elegant way than with full NAOs).

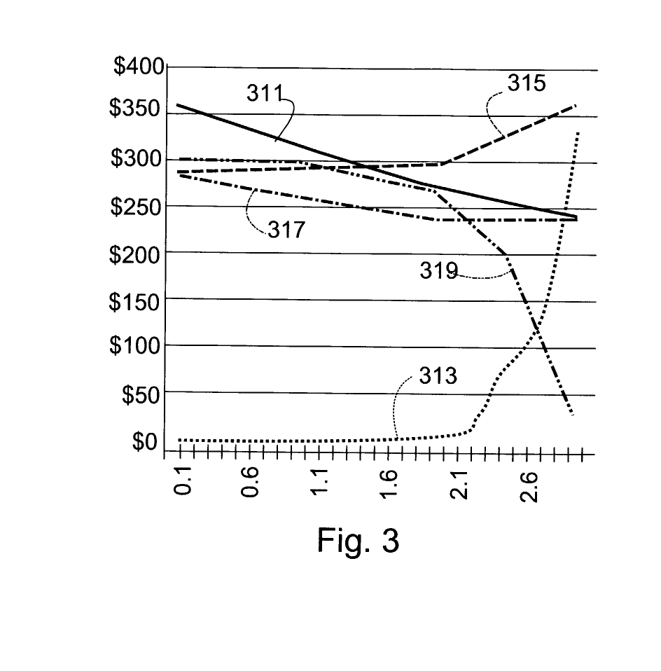

The curve 313 seen in FIG. 3 depicts the historical probability of the interest rate, using Moody's 10-year AA corporate interest rates as a proxy for the annuitization rate (the vertical axis is unitless for this quantity). In the last century, these rates were below 3% for only 10 years, roughly from 1940 to 1950.

The curve at 315 is a surmised value to show the reduction in adverse selection in terms of the median life expectancy of the annuitants, in months. The curve at 317 recalculates the price of the annuity based on the changed life expectancy assumption. The assertion is that with interest rates falling below the benchmark rate, the annuity option will look increasingly better than the lump sum.

The last factor needed to complete the estimation is the probability of exercise shown as curve 319. Since the normalized annuity is defined conservatively, it is not certain that just because interest rates are below the benchmark and the annuity is theoretically a better value than the lump sum, that holders will exercise the option. It may be estimated that exercise rates would rise from less than 10% at the benchmark interest rate, based on current rates of conversion, to perhaps 80% or 90% when interest rates approach zero. (The scale for this quantity is not shown on the graph.) Amending the estimate, we get

$$P = {( 1 + i )}^{- T} {\int }_{0}^{∞} {Pr ( r )}_{T} \cdot ( pv ( r , x ( r ) , 1 ) - L ) \cdot Pr ( Exer ( r ) ) \frac{ⅆ}{ⅆ r}$$

where we substitute life expectancy as a function of r to address reduced adversion, and add a term for the probability of exercise. Note the integration over all positive interest rates, instead of rates from zero to the benchmark rate. Actual behaviors of some shareholders are likely to be at variance from ‘rational’ decisions: some will choose to annuitize even if market rates at maturity are higher than the benchmark, and many will choose the lump sum even if market rates are below the benchmark. Convenience is a motivation in the first case, and flexibility is a motivation in the second.

Note that as the maturity nears, if rates approach or fall below the benchmark (i.e., the interest rate put will be in the money), the value of the options will increase.

### Building Pension Shares

The preferred method for creating the duration-specific portfolios needed to back Pension Shares utilizes, as its basic component, a Fixed Terminal Value (FTV) security with standardized features regarding maturity and creditworthiness. Financially, the FTV component of a Pension Share is a zero-coupon bond. FTVs can be written by underwriters such as insurance companies, or can be created as asset-backed securities (ABS). An exchange mechanism may be employed to aggregate raw FTV-like contracts or securities, reinsure the pools against default risk, and write standardized, insured FTVs for use by Pension Share issuers.

A Longitudinal CBO/CDO (Collateralized Bond/Debt Obligation) accomplishes the same function, except it does not present itself as an exchange for pooling and trading FTVs, but simply as an issuer of ABSs (Asset-backed Securities).

CDOs are structured investment vehicles that allow the “tranching” of risk attributable to a portfolio of fixed income securities. The capital structure of a CDO closely resembles that of a conventional finance company or a bank in that it typically consists of senior and subordinated debt, as well as equity. Substantially all of the debt issued by a CDO is typically rated by one or more rating agencies and is secured, in order of priority, by the underlying portfolio, which is frequently referred to as “collateral.” A CDO manager is responsible for selecting and monitoring the credit quality of the portfolio during the life of a CDO. The term “longitudinal” refers to the fact that the tranches are segregated by maturity rather than by repayment seniority. In effect, pools of bonds or other debt obligations are ‘stripped’ in much the same fashion as Treasury STRIPS. Strictly speaking, this structure is more like Certificates of Accrual on Treasury Securities (CATS) and Treasury Investment Growth Receipts (TIGRs) since a party separate from the underlying issuer is doing the stripping.

The stripping function of the Longitudinal CDO can be accomplished by cooperating Pension Share issuers. While it is less elegant for the Pension Share issuers to be performing these functions (an issuer is expected to be a mutual fund, and the process seems excess for a mutual fund), it should avoid prohibited related party transactions.

For Pension Shares with maturities less than about 10 years, it is efficient to have managed-duration portfolios based on passively managed bond index finds, which themselves have very low costs. The following description is accordingly concerned primarily with portfolios for longer durations.

### Issuer-level Stripping

A Pension Share issuer can simulate the purchase of FTVs by managing a pool of non-callable fixed-income securities, insuring the pool against default risk, and selling any coupons or principal repayments that are not needed to back that issuer's particular Pension Share maturity. Multiple issuers may cooperate in the sense that, since they are each issuing a different maturity, each can use the parts of the portfolio that the more distant maturity issuers sell.

### EXAMPLE

Assume that Pension Shares are to be issued with annual maturities ranging from 2007 to 2022. All of the Pension Shares have a defined liquidation date, such as June 30 of the maturity year. For this example, insurance and other costs will be ignored, and the arithmetic is simplified by assuming a flat yield curve of 5% for all terms 0 to 20 years. On the day of this example, each Pension Share issuer receives an order to purchase $1,000,000 of Pension Shares. The 2022 fund buys $2,693,620 face amount of non-callable bonds with a 5% coupon due Jun. 30, 2022. How can the fund buy bonds worth 2.7 times the amount of money it has to invest? It will sell (strip) the coupons for all years prior to the maturity year. By selling the coupons in annual tranches, it is issuing FTVs. However, to fit in current regulatory frameworks, which don't allow a fund to issue senior securities, it may be necessary to form this as a forward contract.

The 2022 fund will sell the coupons due in 2021 for $51,220 (the present value of the $129,429 in coupons discounted at 5%). The fund sells the 2020 coupons for $53,780, and so on down to the first coupons payable. The total receipts for the stripped coupons are $1,693,620, which happens to equal $2,693,620 minus $1,000,000. So the fund has a net investment equal to the inflow (the net share purchases for the day), and at maturity the fund has $2,693,620 in principal, the face amount of the bonds, to pay the lump sum amount for that day's newly issued Pension Shares (a5% return compounded).

The 2021 fund is a buyer of the 2021 coupons, but still has $948,780 to invest. It buys $2,564,190 face amount of bonds due in 2021, and repeats the same stripping process as the 2022 fund. And so on down to the nearest maturing fund.

### Discussion

For marketing reasons, it is anticipated that Pension Shares will not be initially issued with maturities less than about five years or more than twenty years, but that new Pension Shares with a new twenty year maturity will be issued each year. Of course, five years after the first issuance, there will always be a maturity in each of the next twenty years. Until that time when there are funds maturing within a year, however, the near coupons will need to be sold on the open market to third-party buyers. In practice, all transfers of coupons or FTV-equivalents need to be through the market, or at least exposed to the market, so that the prices are correct and to avoid regulations against related-party transactions. Also, it may sometimes be the case that the net demand at a distant maturity is so much in excess of near maturity demand that not all coupons can be absorbed by the near funds, in which case the excess must be sold to third parties.

### Portfolio Construction

As soon as redeemable open-ended FTV contracts are available, there will be no need to manage a portfolio at the fund level, other than to see that all assets are always invested. Until then, each maturity will need its assets to be managed for maximum returns while minimizing disruption due to any days of net redemptions. As discussed above, a three- or even four-tiered portfolio may be needed consisting of cash, a Zeroes Portfolio of treasury and agency zero-coupon STRIPS, a Core Portfolio of insured corporates and forward contracts and liquid FTVs, and illiquid no-put FTVs and Bullet GICs (Guaranteed Investment Certificates).

It is important to accurately estimate the “maximum short-term cumulative net redemption”, or, from some high watermark of assets, what level of net redemptions can be tolerated before assets must be sold at a ‘distressed price’ (i.e., at the bid price of a wide spread). If there is a redemption charge of, say, 1% paid into the portfolio, then this is much less critical, as over time the redemption charge will cover the spreads. It will also be important to have prior notice of mass redemptions, such as a large retirement plan being transferred to a provider without Pension Share products.

Redemption Costs. The redemption fee can be smaller than 1%. To estimate the minimum fair redemption fee, use a relation such as:

$$K = \frac{{\sum }_{n} {r}_{d} \cdot s ( {r}_{d} )}{{\sum }_{n} {R}_{d}}$$

where K is the redemption cost estimated by looking ahead (or back) n days and taking the net redemption dollars r times the average asset-price spread encountered to meet that level of redemptions s(r) as a ratio to all redemption dollars R that day. The net redemption is r=max(R−P,0), where P is purchase dollars for the given day. Note that the risk is not just single-day redemptions but series of days with accumulating redemptions. For this reason, an estimate of multiple day drawdown would be most useful.

The size of the fund has an impact on the allocation, so that a fund with only $1M in assets would be required to hold all cash and STRIPS. It will be important to grow the assets quickly to minimize the percentage of inefficient, low yield assets.

Since the cash portfolio is intended only to meet occasional net redemptions and the cash that cannot be efficiently deployed in STRIPS or the Core Portfolio, there is no need for elaborate management of Bills, repos, etc.. Institutional money market or cash management funds should be acceptable.

The Zeroes portfolio needs to be only large enough to meet the maximum short-term cumulative net redemption discussed above, i.e., it acts as a buffer to protect the Core portfolio from inconvenient or untimely redemptions.

The Core portfolio will preferably be the largest component and will consist of diverse investment grade corporate bonds and duration-matched forward contracts. The bonds are stripped by selling the coupons as forward contracts. The forward contracts for a particular fund are bought from longer maturity Pension Share funds or third parties willing to meet the credit requirements and contract terms, and sold to third parties or Pension Share funds with nearer maturities. The corporate bonds (and the bonds' coupons) are insured against default by financial guarantors.

The corporate bonds will be limited to 5% of the fund's total portfolio in any one bond issuer. The guarantor may have additional requirements and limitations.

The forward contracts are simply a payment now in exchange for a single repayment at a specific date in the future. The contract is backed only by the insured Core portfolio, and not by the full faith and credit of the fund, so that the contract defaults if some securities in the Core portfolio default and the guarantor also defaults. A forward contract backed by the coupons of diverse issuers may also be considered diverse by regulators.

Finally, the fund can maintain a limited illiquid portfolio, in order to benefit from higher yields on illiquid contracts for long-term debt.

### Net Asset Value Calculation and Policies

Shares of a Pension Share fund are priced the same way as any other mutual fund, collective trust, or separate account. The net assets of the fund are divided by the number of shares issued. As discussed below, it will be important for Pension Share funds to have redemption fees applied to shares redeemed before maturity. Insofar as some of the assets of a Pension Share fund will not be actively traded, there will have to be a policy for valuing these assets. The discussion which follows therefore also explores the interaction of the Net Asset Value (NAV) with spreads in the funds' assets' prices.

### Impact of NAV Policy, and Sales and Redemptions on Shareholders

The details of NAV calculation wouldn't matter except that in practice, the funds will have to publish a NAV before knowing how many new shares will be sold or how many old shares will be redeemed for cash. To be fair to continuing shareholders of any mutual fund, marginal fund share sales would occur at the marginal asset asked price, and marginal fund share redemptions would occur at the marginal asset bid price. Otherwise, continuing shareholders are slightly diluted by issuing shares at less than the cost of new assets, or continuing shareholders are slightly impaired by redeeming shares for more than the price at which assets can be liquidated.

Most funds minimize this ‘spread drag’ on long-term results by maintaining cash in the portfolio. Impairment in assets due to redemptions in excess of cash can sometimes be minimized by temporary borrowing, delaying redemptions, or redeeming in kind, but is otherwise tolerated as slightly reduced long-term performance. For Pension Share funds, however, this becomes an issue because the objective is to meet a specific NAV target at maturity, and any unplanned costs along the way make that more difficult. Also, it is generally true that cash and highly liquid, low-spread assets have lower long-term returns than less-liquid, high-spread assets, so having to hold cash as insurance against redemptions also lowers overall returns for the shareholders. The way funds usually simulate separate bid and offer prices is with redemption fees that are paid into the portfolio. Funds can have separate bid and offer prices that is typically an expression of front-end loads.

### Policy for Valuing Assets with Large Spreads

Through most of the existence of a Pension Share fund, it will experience net purchases on a daily basis. For this reason, the published NAV should be based on the asked price of fund assets, rather than a midpoint or the bid price. This is because the marginal fund share purchases will tend to require the fund to purchase assets at the asked price. Experience may show that skillful managers can able to improve on this to the benefit of the fund shareholders.

In the event of net redemptions, the fund's intent to meet a target NAV at maturity can be impaired if illiquid assets have to be sold at the bid price, but the fund shares are redeemed at an NAV based on the asked price of the assets. This impairs the value of the shares of the remaining shareholders. This problem is addressed in two ways:

1. The portfolios will contain a portion of highly liquid and efficiently traded securities to meet the majority of days with net redemptions; and

2. The fund can impose a redemption fee that is paid into the portfolio.

The redemption fee probably does not have to be large to protect the fund and the remaining shareholders. The fee can be estimated based on the probability of days of net redemption, and the mix of assets in the fund, as described above. It is estimated that the fee need only to be a fraction of 1%, but may be set to 1% to emphasize the long-term character of Pension Share investments.

However, as maturity nears and many shareholders have to finalize their retirement plans, the probability of net daily redemptions increases. Holders retiring earlier than anticipated may liquidate their holdings in part and holders who recognize they will retire later will exchange to later maturing funds. For any particular fund, the second motivation is likely to balance out (exchanges out to later funds will be balanced by exchanges in from earlier maturities). It is expected that net redemptions will be significant only in the last few years. Fortunately, this corresponds with a narrowing of spreads as the maturity of the assets approaches zero.

The redemption fee may be made inapplicable to exchanges between Pension Share funds, as exchanging is likely to be an important feature for shareholders, and because exchanges will tend to balance out. However, some limit on the number of exchanges will be needed; otherwise, someone intent on using Pension Shares for interest rate speculations could switch between the nearest maturity as a cash equivalent and the farthest maturity as a way to short rates.

### Non-market Assets

The Normalized Annuity Options (NAOs) that allow the Pension Share shareholders to choose to take annuity payments instead of the lump sum at liquidation may not have a public market. The standard contract between Pension Share funds and the NAO underwriters that creates NAOs will need to specify terms for premature redemption or a put feature. Ideally, the underwriters will create a market by publishing competitive bids and offers for new NAO units. Each business day, the inside spread set by the underwriters is used to value the NAO units held by the funds.

The spread of NAO prices will also need to be reflected in the funds' redemption fees. The extreme case is that NAO spreads are large (10% or more?) and NAO values become large compared to the NAV. For example, if long-term interest rates drop to 0%, the NAO will be worth about $50 compared to the lump sum value of $200-250, so the NAO spread itself would be around 1% of NAV. Note that in the U.S., historically, the lowest long-term rates for valuing NAOs has been about 2.5%.

The principal terms of a specific illustrative Pension Share offering maturing in the year 2022 is set forth below in an illustrative prospectus. In the example, specific variables which are calculated at the time of issue are shown in brackets.

### EXAMPLE PENSIONSHARES™ 2022 FUND PROSPECTUS

### Investment Objective

The Fund seeks to preserve principal and achieve a target payout to shareholders upon the Fund's planned liquidation in 2022.

### Principal Investment Strategies

The Fund invests primarily in a combination of

Zero coupon bonds and other instruments known generally as “STRIPS” —investments based on the separately traded interest and principal components of securities issued by the U.S. Treasury or U.S. Government agencies and guaranteed by the full faith and credit of the U.S. Government.

Investment grade fixed-income securities such as long-term corporate bonds and other corporate fixed-income obligations. Investment grade bonds are those rated Baa3 or better by Moody's Investors Service, Inc., BBB—by Standard & Poor's (“S&P”), or the equivalent by another independent rating agency.

Forward contracts and other derivatives instruments that separate the interest and principal components of investment grade fixed-income securities. The Fund will not use derivatives as speculative or leveraged investments.

Additionally, the Fund will purchase sufficient options for future delivery of annuity life insurance policies to provide the Shareholder Annuity Option described below.

The Fund's investment adviser manages the Fund's portfolio to achieve a minimum target payout of $197 per share at the time of the Fund's planned liquidation on Jun. 30, 2022, which is referred to in this prospectus as the “Fund Maturity Date”. The target payout, while not guaranteed by the Fund, is supported by a conservative investment philosophy of investing substantially all of the Fund's portfolio in a combination of U.S. Government and related securities, and investment grade fixed-income securities and related instruments. The ability of the Fund to achieve the target payout is further enhanced by the Fund's purchase of insurance supporting the credit quality of certain of the non-U.S. Government fixed-income securities in the Fund's portfolio. This insurance essentially insulates these investments from the types of credit risks described below.

The Fund's investments are focused on achieving the minimum target payout on the Fund Maturity Date, and are managed without regard to current income.

Shareholder Annuity Option. For each Fund share you own on the Fund Maturity Date, you will have the choice of receiving

A lump sum cash payment equal to the actual net asset value per share achieved by the Fund, which is expected to be at least equal to the minimum target payout.

An option and sufficient cash to purchase an annuity insurance contract paying $1.00 per month for life, in effect providing you with a lifetime pension equal to $1.00 per month for each share you own. The option will automatically be exercised immediately following its distribution to you by the insurance company providing the annuity contract. The value of the annuity payments may be reduced if the Fund does not achieve its target payout. Additionally, the value of the actual annuity payments will be set at the time the contract is issued, and may be adjusted at that time based on your age and the number of beneficiaries as described in the “Annuity Payment Adjustments” section below.

A combination of a cash payment for some shares and an option to purchase a life annuity contract for your other shares.

### Annuity Payment Adjustments

The option to purchase a life annuity contract paying $1.00 per month for each share you own is based on two assumptions in addition to your Fund achieving its minimum target payout: (1) that there are two spousal annuitants (or beneficiaries), and (2) that both annuitants are [67] years old on the Fund Maturity Date. Your actual contract payments will be adjusted based on your situation at the time the contract is issued. For example, if you are single with no spousal beneficiary, the contract payments will be increased. Likewise, if you older than [67] the payments will be increased, but if you are younger than [67] the payments will be decreased. The Funds are designed with the expectation that most investors will choose a Fund with a Fund Maturity Date closest to the time when they will actually turn 67 to minimize the adjustments to the annuity contract payments from $1.00 per month per share. The table below shows in more detail how any adjustments will be made.

### [Table omitted]

### Principal Risks

An investment in the Fund could lose money, and is not insured or guaranteed by the Federal Deposit Insurance Corporation or any other government agency. The Fund's performance could be hurt by

Interest rate risk, which is the chance that bond prices overall will decline over short or even long periods because of rising interest rates. This risk is increased to the extent the Fund invests mainly in long-term bonds, which have prices that are much more sensitive to interest rate changes than are the prices of shorter-term bonds. This risk is greatest for shareholders who do not hold their shares until the Fund Maturity Date. The Fund's investment adviser uses “bond immunization” techniques to protect the ultimate value of the portfolio at the Fund Maturity Date, but bond immunization does nothing to minimize share price volatility before that date.

Credit risk, which is the chance that a bond issuer will fail to pay interest and principal in a timely manner. Credit risk should be low for the Fund because it invests mainly in U.S. Government securities and corporate bonds that are considered investment grade. The Fund may at times purchase insurance supporting the credit quality of certain of the non-U.S. Government fixed-income securities in the Fund's portfolio. This insurance essentially insulates these investments from credit risk.

Liquidity risk, which is the risk that certain securities held by the Fund may be difficult to sell for a variety of reasons, such as the lack of an active trading market.

### Is the Fund A Suitable Investment FOR Me?

The Fund may be a suitable investment for you if you

Are investing through an IRA or other tax-deferred retirement plan (such as a 401(k) plan).

Have long-term financial goals for your investment, such as retirement, that correspond with the Fund Maturity Date.

Wish to combine the benefits of a “defined contribution” (your investment) with a “defined benefit” (the minimum target payout or Shareholder Annuity Option).

The Fund probably is not a suitable investment for you if you

Are seeking current income.

Are a short-term investor.

### Fees and Expenses

The following table describes the fees and expenses you may pay if you buy and hold shares of the Fund. The expenses shown under Annual Fund Operating Expenses are based on estimates for the current fiscal year ending Dec. 31, 2002.

SHAREHOLDER FEES (fees paid directly from your investment)

| | |
|---|---|
| Sales Charge (Load) Imposed on Purchases: | None |
| Sales Charge (Load) Imposed on Reinvested | None |
| Dividends: | |
| Redemption Fee: | [1] % (see Note 1) |
| Exchange Fee: | None |

ANNUAL FUND OPERATING EXPENSES (expenses deducted from the Fund's assets)

| | |
|---|---|
| Management Expenses: | [ ] % |
| 12b-1 Distribution Fee: | None |
| Other Expenses: | [ ] % |
| TOTAL ANNUAL FUND OPERATING EXPENSES: | [ ] % |

Note 1: A redemption fee is assessed by the Fund as follows: 1% on all redemptions prior to [Jun. 30, 20 ______ ], 0.75% on all redemptions prior to [Jun. 30, 20______ ], and 0.5% thereafter on all redemptions prior to Jun. 30, 2022. The redemption fee does not include a one time service fee of up to [$500] that may be assessed by the insurance provider for each annuity life insurance contract you purchase following liquidation of the Fund.

The following examples are intended to help you compare the cost of investing in the Fund's shares with the cost of investing in other mutual finds. They illustrate the hypothetical expenses that you would incur over various periods if you invest $10,000 in the Fund's shares and then redeem you shares at the end of those period. These examples assume that the Fund provides a return of 5% a year and that operating expenses remain the same. Although your actual costs may be higher or lower, based on these assumptions your costs would be:

| 1 YEAR | 3 YEARS | 5 YEARS | 10 YEARS |
|---|---|---|---|
| $[ ] | $[ ] | $[ ] | $[ ] |
| $[ ] | $[ ] | $[ ] | $[ ] |

If you did not redeem your shares, your costs would be:

| 1 YEAR | 3 YEARS | 5 YEARS | 10 YEARS |
|---|---|---|---|
| $[ ] | $[ ] | $[ ] | $[ ] |
| $[ ] | $[ ] | $[ ] | $[ ] |

### More Information about the Funds

Below you will find more detail about the principal investment strategies and policies that the Funds use in pursuit of their investment objectives. The Funds' Board of Trustees, which oversees the Funds' investment adviser, may change investment strategies or policies without a shareholder vote, unless those strategies or policies are designated as fundamental. Note that each Fund's investment objective is not fundamental and may be changed without a shareholder vote.

The balance of the prospectus includes information on other important features of the Funds.

### Investment Strategies and Portfolio Management

The investment adviser manages each Fund's portfolio to protect principal while achieving the target payout for that Fund at its planned liquidation date (June 30 of the year for which the Fund is named), as described above in the Fund's summary under “Principal Investment Strategies”. Under normal market conditions, substantially all of a Fund's portfolio will be invested in a combination of cash, U.S. Government securities, investment grade corporate bonds, and related derivative securities (generally forward contracts for bond coupon payments). These investments are meant to financially replicate a “zero coupon” security sufficient in value to at least meet the target payout.

The expected likelihood of a Fund achieving its target payout is based on the conservative use of investments described above, and is further enhanced by the Fund's purchase of insurance supporting the credit quality of certain of the non-U.S. Government fixed-income securities in the Fund's portfolio. This insurance essentially insulates these investments from the types of credit risks described below.

Each Fund will purchase sufficient options for future delivery of annuity insurance policies to provide the Shareholder Annuity Option. Absent unusually low market interest rates at the time of the Fund Maturity Date, the value of these options is not expected to represent a significant portion of the value the Fund's portfolio. The options will be issued by various insurance providers selected by the Fund's investment adviser.

A Fund may use derivative securities for other non-speculative purposes as described below under “Derivatives Risk”.

The Funds are generally managed without regard to tax ramifications.

Temporary Investment Measures. Each Fund may temporarily depart from its normal investment policies—for instance, by allocating substantial assets to cash investments—in response to extraordinary market, economic, political, or other conditions. In doing so, the Fund may succeed in avoiding losses but otherwise fail to achieve its investment objective.

### Principal and Other Investment Risks

The Funds invest mainly in bonds. As a result, they are subject to certain risks.

### Bonds And Interest Rates

As a rule, when interest rates rise, bond prices fall. The opposite is also true:

Bond prices go up when interest rates fall. Therefore, each Fund is subject to Interest Rate Risk, which is the chance that bond prices overall will decline over short or even long periods because of rising interest rates. Depending on the planned liquidation date of a Fund, Interest Rate Risk will tend to vary—it should be low for short-term Funds, moderate for intermediate-term funds, and higher for long-term Funds.

Why do bond prices and interest rates move in opposite directions? Let's assume that you hold a bond offering a 5% yield. A year later, interest rates are on the rise and bonds of comparable quality and maturity are offered with a 6% yield. With higher-yielding bonds available, you would have trouble selling your 5% bond for the price you paid—you would probably have to lower your asking price. On the other hand, if interest rates were falling and 4% bonds were being offered, you should be able to sell your 5% bond for more than you paid.

### Bonds and Maturity

Although bonds are issued with a specific maturity date, a bond issuer may be able to redeem, or call, a bond earlier than its maturity date. The bondholder must now replace the called bond with a bond that may have a lower yield than the original. Therefore, because each Fund may invest in bonds that are callable, each Fund is subject to Call Risk, which is the chance that during periods of falling interest rates a bond issuer will call—or repay—a higher-yielding bond before its maturity date. The Fund could lose the opportunity for additional price appreciation, and could be forced to reinvest the unanticipated proceeds at lower interest rates. As a result, the Fund could experience a decline in income and the potential for taxable capital gains. However, because the Fund expects that its investments in callable bonds will primarily be made to manage portfolio duration in circumstances where the bonds' issuers are expected to call the bonds, this is not considered to be a principal risk of the Fund.

### Bonds and Credit Risk

A bond's credit quality depends on the issuer's ability to pay interest on the bond and, ultimately, to repay the principal. Credit quality is evaluated by one of the independent bond-rating agencies (for example, Moody's or Standard & Poor's). The lower the rating, the greater the chance—in the rating agency's opinion—that the bond issuer will default, or fail to meet its payment obligations. All things being equal, the lower a bond's credit rating, the higher its yield should be to compensate investors for assuming additional risk. Bonds rated Baa 3 or better by Moody's, BBB—by S&P, or the equivalent by another independent rating agency are considered investment grade and are eligible for purchase by the Funds.

All of the Funds are therefore subject to Credit Risk, which is the chance that a bond issuer will fail to pay interest and principal in a timely manner.

### Derivatives Risk

A derivative is a financial contract whose value is based on (or “derived” from) a traditional security (such as a stock or a bond), an asset (such as a commodity like gold), or a market index (such as the S&P 500 Index). Some forms of derivatives, such as exchange-traded futures and options on securities, commodities, or indexes, have been trading on regulated exchanges for more than two decades. These types of derivatives are standardized contracts that can easily be bought and sold, and whose market values are determined and published daily. Nonstandardized derivatives (such as swap agreements or forward contracts), on the other hand, tend to be more specialized or complex, and may be harder to value. If used for speculation or as leveraged investments, derivatives can carry considerable risks.

The Funds will use forward contracts based on the interest coupons payable on investment grade corporate and other bonds. Forward contracts, futures, options, and other derivatives may represent up to [ ]% of a Fund's total assets. In addition to forward contracts relating to coupons payable on bonds, these investments may be in bond futures contracts, options, credit swaps, interest rate swaps, and other types of derivatives. Losses (or gains) involving futures can sometimes be substantial—in part because a relatively small price movement in a futures contract may result in an immediate and substantial loss (or gain) for a Fund. Similar risks exist for other types of derivatives. For this reason, the Funds will not use forwards, futures, options, or other derivatives for speculative purposes or as leveraged investments that magnify the gains or losses of an investment. A Fund may invest in futures, options and other derivatives to keep cash on hand to meet shareholder redemptions or other needs while simulating full investment in bonds; to reduce the Fund's transaction costs; for hedging purposes; or to add value when these instruments are favorably priced.

### Illiquid Securities

Illiquid securities are securities that a Fund may not be able to sell in the ordinary course of business. Each Fund may invest up to 15% of its net assets in these securities. Restricted securities are a special type of illiquid security; these securities have not been publicly-issued and legally can be resold only to qualified institutional buyers. From time to time, the Board of Trustees may determine that particular restricted securities are NOT illiquid, and those securities may then be purchased by a Fund without limit.

### U.S. Treasury Policy Risk

The U.S. Treasury has announced its intention to cease issuing treasury bonds with maturities longer than 10 years. This will reduce the ability of the Funds to use Treasury securities for high credit quality, high-liquidity long-term investments. It may also mean that the interest rates on existing long-term Treasuries will decline as demand exceeds the limited supply.

### Management Risk

Each Fund is subject to Management Risk, which is the risk that the Fund's investment adviser may choose not to use a particular investment strategy or type of security for a variety of reasons. These choices may cause the Fund to miss opportunities, lose money or not achieve its investment objective.

### Portfolio Turnover

Although the Funds normally seek to invest for the long term and portfolio turnover is not expected to exceed 100% annually (and may be much lower), each Fund may sell securities regardless of how long they have been held. Portfolio turnover contributes to transaction costs, such as brokerage commissions, that may affect a Fund's performance. Higher turnover rates may also be more likely to generate capital gains that must be distributed to shareholders as taxable income.

### Market-timimg

Some investors try to profit from a strategy called market-timing—switching money into mutual funds when they expect prices to rise and taking money out when they expect prices to fall. As money is shifted in and out, a Fund incurs expenses for buying and selling securities. These costs are borne by all Fund shareholders, including the long-term investors who do not generate the costs. This is why the Funds have adopted special policies to discourage short-term trading or to compensate the Funds for the costs associated with it. Specifically

Each Fund reserves the right to reject any purchase request-including exchanges from other Funds—which it regards as disruptive to efficient portfolio management. A purchase request could be rejected because of the timing of the investment or because of a history of excessive trading by the investor.

Each Fund limits the number of times that an investor can exchange into and out of the fund (presently once in any 12 month period).

Each Fund reserves the right to stop offering shares at any time.

Each Fund charges a redemption fee as described in the Fund's “Fees and Expenses” table.

### Fund Distributions

Each Fund distributes to shareholders virtually all of its net income (interest less expenses), as well as any capital gains realized from the sale of its holdings. The Funds' income dividends accrue daily and are distributed, together with capital gains, once each year in December. In addition, the Funds may occasionally be required to make supplemental capital gains distributions at other times during the year. When the distribution is made, the share price decreases by the amount of the per-share distribution. Your distribution is automatically re-invested in the Funds' shares, so that your total Fund holdings have the same value as before the distribution. To ensure that you also have the same number of shares after the distribution as before, the Fund's Board of Trustees also declares a reverse share split that offsets the per-share amount of the distribution. This is important so that the target payout and the monthly benefit per share also remain unchanged after a distribution.

### Share Price

Each Fund's share price, called its net asset value, or NAV, is calculated each business day after the close of regular trading on the New York Stock Exchange, generally 4 p.m., Eastern time. NAV is computed by dividing the net assets attributed to each share class by the number of Fund shares outstanding for that class. On holidays or other days when the Exchange is closed, the NAV is not calculated, and the Fund will not transact purchase or redemption requests. However, on those days the value of a Fund's assets may be affected to the extent that the Fund holds foreign securities that trade on foreign markets that are open.

Bonds held by a Fund are valued based on information furnished by an independent pricing service or market quotations. Certain short-term debt instruments used to manage a fund's cash are valued on the basis of amortized cost.

When pricing service information or market quotations are not readily available, securities are priced at their fair value, calculated according to procedures adopted by the Board of Trustees. A Fund also may use fair-value pricing if the value of a security it holds is materially affected by events occurring after the close of the primary markets or exchanges on which the security is traded. This most commonly occurs with foreign securities, but may occur in other cases as well. When fair-value pricing is used, the prices of securities used by a fund to calculate its net asset value may differ from quoted or published prices for the same securities.

### Purchase of Shares

Each Fund reserves the right in its sole discretion to reduce or waive the minimum investment for or any other restrictions on initial and subsequent investments for certain fiduciary accounts such as employee benefit plans or under circumstances where certain economies can be achieved in sales of the Fund's shares.

### Redemption of Shares

Before the Fund Maturity Date. Shares of each Fund may be redeemed on any day when the New York Stock Exchange is open for regular trading. The redemption price is the NAV per share next determined after receipt of the redemption request in good order, less the applicable redemption fee, if any. Payment on redemption will generally be made as promptly as possible. However, a Fund may delay sending you the proceeds for up to seven days after the request for redemption are received by the Fund in good order.

On the Fund Maturity Date. It is expected that the Board of Trustees will liquidate each Fund on its Fund Maturity Date, which is June 30 of the year after which the Fund is named. For each Fund share you own on the Fund Maturity Date (or the actual liquidation date, if different), you will have the choice of receiving

A lump sum cash payment equal to the actual net asset value per share achieved by the Fund, which is expected to be at least equal to the minimum target payout.

An option and sufficient cash to purchase an annuity insurance contract paying $1.00 per month for life, in effect providing you with a lifetime pension equal to $1.00 per month for each share you own. The option will automatically be exercised immediately following its distribution to you by the insurance company providing the annuity contract. The value of the annuity payments may be reduced if the Fund does not achieve its target payout. Additionally, the value of the actual annuity payments will be set at the time the contract is issued, and may be adjusted at that time based on your age and the number of beneficiaries as described in the “Annuity Payment Adjustments” section in the Fund's summary above.

A combination of a cash payment for some shares and an option to purchase a life annuity contract for your other shares.

### Generally

Each Fund may suspend redemption privileges or postpone the date of payment: (i) during any period that the New York Stock Exchange is closed, or trading on the Exchange is restricted as determined by the Securities and Exchange Commission (the “SEC”), (ii) during any period when an emergency exists as defined by the SEC as a result of which it is not reasonably practicable for a Fund to dispose of securities owned by it, or fairly to determine the value of its assets, and (iii) for such other periods as the SEC may permit.

Except for the redemption fee described in each Fund's “Fees and Expenses” table, there are no charges associated with a redemption. A Fund will always redeem your oldest shares first. From time to time, a Fund may waive or modify redemption transaction fees for certain categories of investors.

Each Fund generally will make all redemption payments in cash, but reserves the right to make redemptions wholly or partly in-kind if the investment advisers determines, in its sole discretion, that it would be detrimental to the Fund's remaining shareholders to make a particular redemption wholly or partly in cash. Any redemption in-kind will be in the form of readily marketable securities selected by the Fund's investment adviser from the Fund's portfolio. These securities would be valued in the same way the Fund determines its NAV. In-kind distributions may be made without prior notice, and you may have to pay brokerage or other transaction costs to convert the securities to cash.

### Exchanging Shares

You may exchange your shares for shares of any other PensionShares Fund without payment of any exchange fee. However, the exchange privilege is limited to one exchange in any 12 month period.

### Shareholder Taxes

The Funds are intended for purchase by investors through tax-deferred accounts such as IRA and 401(k) accounts. However, if you are a taxable investor, the Fund will send you a statement each year showing the tax status of all your distributions. In addition, taxable investors should be aware of the following basic tax points:

Distributions are taxable to you for federal income tax purposes whether or not you reinvest these amounts in additional Fund shares.

Distributions declared in December—if paid to you by the end of January—are taxable for federal income tax purposes as if received in December.

Any dividends and short-term capital gains that you receive are taxable to you as ordinary income for federal income tax purposes.

Any distributions of net long-term capital gains are taxable to you as long-term capital gains for federal income tax purposes, no matter how long you've owned shares in the Fund.

Capital gains distributions may vary considerably from year to year as a result of the Funds' normal investment activities and cash flows.

A sale or exchange of Fund shares is a taxable event. This means that you may have a capital gain to report as income, or a capital loss to report as a deduction, when you complete your federal income tax return.

Dividend and capital gains distributions that you receive, as well as your gains or losses from any sale or exchange of Fund shares, may be subject to state and local income taxes. Depending on your state's rules, however, any dividends attributable to interest earned on direct obligations of the U.S. government may be exempt from state and local taxes. Your Fund will notify you each year how much, if any, of your dividends may qualify for this exemption.

### Tax Status of the Funds

Each Fund intends to continue to qualify as a “regulated investment company” under Subchapter M of the Internal Revenue Code of 1986, as amended. This special tax status means that a Fund will not be liable for federal tax on income and capital gains distributed to shareholders. In order to preserve its tax status, each Fund must comply with certain requirements. If a Fund fails to meet these requirements in any taxable year, it will be subject to tax on its taxable income at corporate rates, and all distributions from earnings and profits, including any distributions of net tax-exempt income and net long-term capital gains, will be taxable to shareholders as ordinary income. In addition, a Fund could be required to recognize unrealized gains, pay substantial taxes and interest, and make substantial distributions before regaining its tax status as a regulated investment company.

### Glossary of Investment Terms

AVERAGE MATURITY: The average length of time until bonds held by a fund reach maturity (or are called) and are repaid. In general, the longer the average maturity, the more a fund's share price will fluctuate in response to changes in market interest rates.

BOND: A debt security (IOU) issued by a corporation, government, or government agency in exchange for the money you lend it. In most instances, the issuer agrees to pay back the loan by a specific date and make regular interest payments until that date.

BOND IMMUNIZATION: This describes the selection of a bond portfolio so that the ultimate value of the portfolio over a specified period of time is immune to changes in interest rates, even though the day-to-day value of the portfolio will change because of interest rate changes. If the portfolio is not immunized, there is risk that the reinvestment of bond interest payments at lower interest rates would cause the ultimate value of the portfolio to be lower than expected based on the interest rate structure at inception. A condition for a Fund's portfolio to be immunized is that the duration of the portfolio is the same as the time to maturity for the fund.

CAPITAL GAINS DISTRIBUTION: Payment to mutual fund shareholders of gains realized on securities that a fund has sold at a profit, minus any realized losses.

CASH INVESTMENTS: Cash deposits, short-term bank deposits, and money market instruments that include U.S. Treasury bills, bank certificates of deposit (CDs), repurchase agreements, commercial paper, and banker's acceptances.

DIVIDEND INCOME: Payment to shareholders of income from interest or dividends generated by a fund's investments.

DURATION: The duration of a bond portfolio is the average time to repayment of the bonds, including interest payments as well as the final principal repayments. Duration will be less than the average maturity if the bond pays interest; for zero-coupon bonds, duration equals time to maturity. Duration is also a measure of the volatility of the portfolio, so long-duration is the same as highly-volatile.

EXPENSE RATIO: The percentage of a fund's average net assets used to pay its expenses during a fiscal year. The expense ratio includes management fees, administrative fees, and any 12b-1 distribution fees.

FACE VALUE: The amount to be paid at a bond's maturity; also known as the par value or principal.

FIXED-INCOME SECURITIES: Investments, such as bonds, that have a fixed payment schedule. While the level of income offered by these securities is predetermined, their prices may fluctuate.

INVESTMENT ADVISER: An organization that makes the day-to-day decisions regarding a fund's investments.

INVESTMENT GRADE: A bond whose credit quality is considered by any independent bond-rating agency to be sufficient to ensure timely payment of principal and interest under current economic circumstances. Bonds rated Baa3 or better by Moody's Investors Service, Inc., BBB—by Standard & Poor's (“S&P”), or the equivalent by another independent rating agency are considered investment grade.

MATURITY: The date when a bond issuer agrees to repay the bond's principal, or face value, to the bond's buyer.

NET ASSET VALUE (NAV): The market value of a mutual fund's total assets, minus liabilities, divided by the number of shares outstanding. The value of a single share is also called its share value or share price.

PRINCIPAL: The amount of money you put into an investment.

TOTAL RETURN: A percentage change, over a specified time period, in a mutual fund's net asset value, assuming the reinvestment of all distributions of dividends and capital gains.

VOLATILITY: The fluctuations in value of a mutual fund or other security. The greater a fund's volatility, the greater the change in day-to-day values, and the less reliable the fund is for short-term investment.

YIELD: Income (interest or dividends) earned by an investment, expressed as a percentage of the investment's price.

### End of PENSIONSHARES 2022 FUND EXAMPLE

### Conclusion

It is to be understood that the foregoing detailed description of the preferred methods for practicing the invention are merely illustrative applications of the principles of the invention. Numerous modifications may be made to the specific methods described without departing from the true scope and spirit of the invention.

What is claimed is:

1. The method of issuing and managing investment instruments which comprises, in combination, the steps of:
establishing an investment fund,
creating a security which represents a claim against and is secured by said investment fund, said security entitling its holder to receive, at one or more future maturity dates specified by said security, either a lump sum payment amount or, at the option of said holder, to receive a sequence of annuity payments, the amount and payment date of each of said annuity payments being specified by said security,
transferring said security to a purchaser in exchange for a purchase price amount,
depositing at least a substantial portion of said purchase price amount into said find,
investing the assets of said fund so that the net asset value of said find at said maturity date should be adequate to pay to said holder either said lump sum payment amount or an amount adequate to purchase said annuity, and
on or after said maturity date, transferring either said lump sum payment amount or said annuity to said holder as elected by said holder.

2. A method for producing and distributing investment securities comprising, in combination, the steps of:
creating a security which comprises a contract in which the issuer of the security promises to pay to the holder of the security a predetermined guaranteed lump sum cash payment at a predetermined maturity date or to pay, in the alternative and at the option of the holder, a sequence of predetermined annuity payments at defined times, and
issuing said security to a holder in advance of said maturity date in return for a purchase price payment.
